(19) United States
(12) Patent Application Publication
(10) Pub. No.: US 2018/0120098 A1
(43) Pub. Date: May 3, 2018

(54) Volume Estimation Apparatus, Working Machine Including the Same, and Volume Estimation System

(71) Applicant: Hitachi, Ltd., Chiyoda-ku, Tokyo (JP)

(72) Inventors: Shigeru MATSUO, Tokyo (JP); Miyako HOTTA, Tokyo (JP)

(73) Assignee: Hitachi, Ltd., Tokyo (JP)

(21) Appl. No.: 15/566,272

(22) PCT Filed: Apr. 24, 2015
(86) PCT No.: PCT/JP2015/062463

§ 371 Date: Oct. 13, 2017

(51) Int. Cl. G01B 11/245; E02F 9/26; G01F 17/00

(52) U.S. Cl. CPC G01B 11/245; G01F 17/00; E02F 9/26

(57) ABSTRACT

The invention estimates a volume of an object inside a container without deteriorating excavation efficiency at the time of viewing the entire inside of the container with a camera. There is provided a container determination unit which determines whether an inner bottom of a bucket is within a photographing range of a stereo camera device during the work of a hydraulic excavator including the bucket and the stereo camera device; and a volume estimation unit which estimates a volume of an excavated material inside the bucket when the inner bottom of the bucket is within the photographing range of the stereo camera device.

### TECHNICAL FIELD

The present invention relates to a volume estimation apparatus, a working machine including the same, and a volume estimation system.

### BACKGROUND ART

In order to improve the excavation work efficiency in mines, an excavator needs to fill a dump with a predetermined number of times of excavation. Therefore, if the excavation amount per each operation can be known, an operator can adjust the next excavation amount.

As a technique in view of this point, there is known a technique for measuring a volume by photographing an excavated material in a bucket with a stereo camera. For example, PTL 1 describes a method of calculating a loading capacity in a bucket by providing a plurality of cameras at the left and right sides of a boom or an arm and photographing the bucket with a camera located substantially directly above the bucket.

### CITATION LIST

### Patent Literature

PTL 1: JP 2008-241300 A

### SUMMARY OF INVENTION

### Technical Problem

However, in PTL 1, since it is necessary to move the bucket to a specific position so that the entire inside of the bucket enters the photographed image of the camera for volume measurement, the excavation work efficiency is deteriorated.

An object of the invention is to estimate a volume of an object inside a container without deteriorating excavation efficiency at the time of viewing the entire inside of the container with a camera.

### Solution to Problem

A feature of the invention for solving the above-described problems is, for example, as below.

There is provided: a container determination unit 410 which determines whether an inner bottom of a bucket 15 is within a photographing range of a stereo camera device 210 during the work of a hydraulic excavator 1 including the bucket 15 and the stereo camera device 210; and a volume estimation unit 330 which estimates the volume of an excavated material inside the bucket 15 when the inner bottom of the bucket 15 is within the photographing range of the stereo camera device 210.

### Advantageous Effects of Invention

According to the invention, it is possible to estimate a volume of an object inside a container without deteriorating excavation efficiency at the time of viewing the entire inside of the container with a camera. The objects, configurations, and effects other than those described above will be clarified by the description of the embodiments below.

### BRIEF DESCRIPTION OF DRAWINGS

FIG. 1 is an external view of a hydraulic excavator.

FIG. 2 is a configuration diagram of a volume estimation apparatus mounted on a hydraulic excavator of an embodiment of the invention.

FIG. 3 is a flowchart of an embodiment of the invention.

FIG. 4 is a method of creating parallax data by a stereo camera device.

FIG. 5 is an outline of a method of estimating a volume of an excavated material.

FIG. 6 is an example of a case where a dead angle region is formed by a side surface of a bucket.

FIG. 7 is a photographed image in a case where an inner bottom of a bucket is within a photographing range of a stereo camera device.

FIG. 8 is a diagram for defining an inner bottom of a bucket by the use of buckets having four different shapes.

FIG. 9 is an example of mesh parallax data in a case where a dead angle region is formed at an excavated material inside a bucket.

FIG. 10 is a configuration diagram of a volume estimation apparatus mounted on a hydraulic excavator of an embodiment of the invention.

FIG. 11 is an angle measurement method using parallax data instead of a rotation angle.

FIG. 12 is a flowchart of an embodiment of the invention.

FIG. 13 is a configuration diagram of a volume estimation apparatus mounted on a hydraulic excavator of an embodiment of the invention.

FIG. 14 is a flowchart of an embodiment of the invention.

### DESCRIPTION OF EMBODIMENTS

Hereinafter, embodiments of the invention will be described with reference to the drawings. The following description illustrates specific examples of the contents of the invention, the invention is not limited to the description, and various modifications and corrections can be made by those skilled in the art within the scope of the technical spirit disclosed in this specification. Further, in all drawings for describing the invention, those having similar functions are indicated by the same reference numerals, and the same description may not be repeated in some cases.

The control method and the computer program of the invention describe a plurality of steps in order, but the order of description does not limit the order of executing a plurality of steps. Therefore, the order of the plurality of steps can be changed within a range that does not disturb the contents when implementing the control method and the computer program of the invention.

Further, the plurality of steps of the control method and the computer program of the invention are not limited to the execution at individually different timings. For this reason, another step may be executed during the execution of a certain step or the execution timing of a certain step may partly or entirely overlap the execution timing of another step.

### First Embodiment

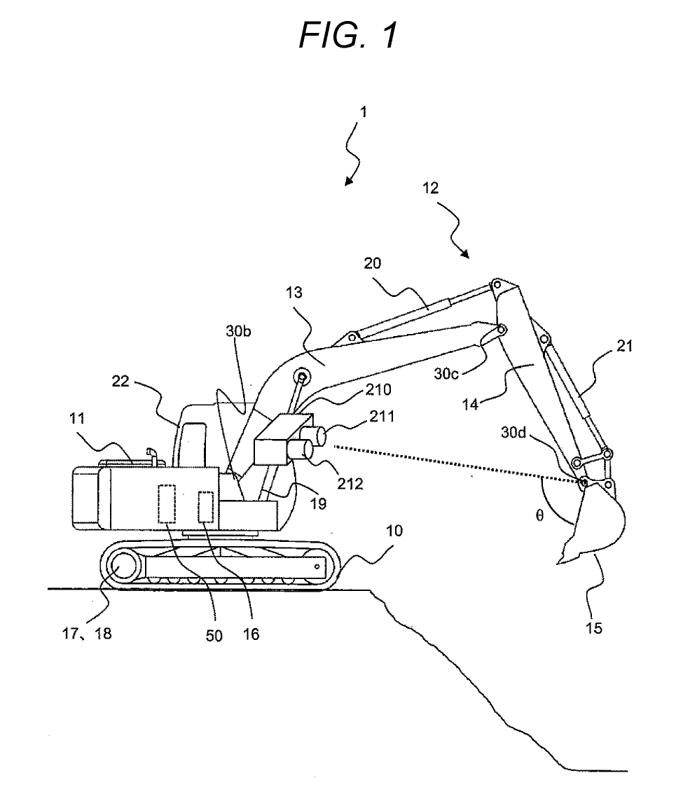

FIG. 1 is an external view of a hydraulic excavator 1 which is an example of a working machine. The hydraulic excavator 1 includes a lower traveling body 10, an upper turning body 11, and a front mechanism 12 of which one end is attached to the upper turning body 11.

The lower traveling body 10 includes a left traveling motor 17 and a right traveling motor 18. The lower traveling body 10 can allow the hydraulic excavator 1 to travel by driving forces of the left traveling motor 17 and the right traveling motor 18.

The upper turning body 11 includes a volume estimation apparatus 50, a turning motor 16, and a cab 22. The upper turning body 11 is provided above the lower traveling body 10 to be turnable by the turning motor 16. A control lever (not illustrated), an operator interface, and a stereo camera device 210 are disposed inside the cab 22 which allows an operator therein to operate the hydraulic excavator 1.

The stereo camera device 210 includes two cameras, aright camera 212 and a left camera 211, and can measure a distance from the stereo camera device 210 to a subject by using the parallax of two cameras. The stereo camera device 210 may include two or more cameras and the number of cameras may be, for example, three or four. Instead of the stereo camera device 210, one or more sensors exhibiting the same effect as that of the stereo camera device 210 may be provided.

The arrangement position of the stereo camera device 210 is not particularly limited as long as an excavated material inside a bucket 15 can be photographed by the stereo camera device 210. In this embodiment, the stereo camera device 210 is disposed at the front side of the cab 22 with respect to the bucket 15. Accordingly, it is possible to suppress a vibration or dirt to the stereo camera device 210.

The front mechanism 12 includes a boom 13 of which one end is provided at the upper turning body 11, an arm 14 of which one end side is provided at the other end side of the boom 13, the bucket 15 which is provided at the other end side of the arm 14, and cylinders 19 to 21.

The boom 13 is rotatable with respect to the upper turning body 11. The arm 14 is rotatable with respect to the other end side of the boom 13. The bucket 15 is rotatable with respect to the other end side of the arm 14. The cylinders 19 to 21 are respectively used to rotate the boom 13, the arm 14, and the bucket 15.

The boom 13, the arm 14, and the bucket 15 respectively include angle sensors 30b, 30c, and 30d for detecting their rotation angles. Hereinafter, a description will be made on the assumption that the angle sensors 30b, 30c, and 30d are totally referred to as an angle sensor 30. An angle θ indicates an angle formed between the stereo camera device 210 and the opening surface of the bucket 15. Hereinafter, a description will be made on the assumption that an angle formed between the stereo camera device 210 and the opening surface of the bucket 15 is referred to as a bucket angle.

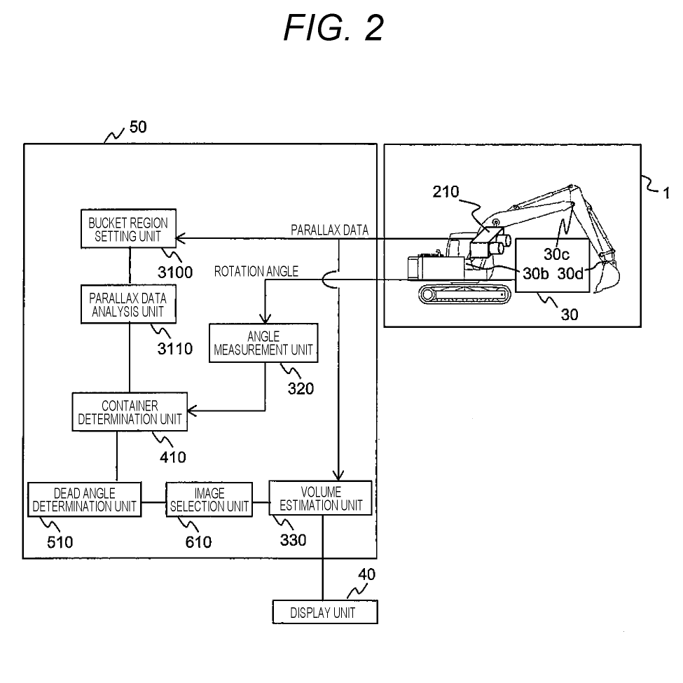

FIG. 2 is a configuration diagram of the volume estimation apparatus 50 mounted on the hydraulic excavator 1. The volume estimation apparatus 50 is a device which estimates the volume of the excavated material inside the bucket 15 photographed by the stereo camera device 210. The volume estimation apparatus 50 includes a bucket region setting unit 3100 which sets a bucket region by separating the bucket 15 from the ground using parallax data obtained from an image photographed by the stereo camera device 210, a parallax data analysis unit 3110 which three-dimensionally converts the parallax data of the set bucket region, an angle measurement unit 320 which obtains a bucket angle, a container determination unit 410 which determines whether the inner bottom of the bucket 15 is within a photographing range of the stereo camera device 210 during the work of the hydraulic excavator 1 including the bucket 15 and the stereo camera device 210, a dead angle determination unit 510 which determines whether a dead angle region exists at an excavated material inside the bucket region, an image selection unit 610 which selects a photographed image used to estimate a volume on the basis of the existence of the dead angle region, and a volume estimation unit 330 which estimates the volume of the excavated material. An excavated material volume estimation result is displayed on a display unit 40.

In this embodiment, a time for performing the excavating operation, the turning operation, and the soil discharging operation of the hydraulic excavator 1 or an operation time between the operations is set as a working time.

The volume measurement apparatus 50 includes a central processing unit (CPU), a random access memory (RAM), a read only memory (ROM), and other peripheral circuits. Here, for example, a method is considered in which the bucket region setting unit 3100 or the image selection unit 610 corresponding to the component of the volume measurement apparatus 50 is stored in the ROM and its function is executed by the CPU using the RAM.

When the display unit 40 is configured as, for example, a display provided inside the cab 22, the excavated material volume estimation result can be displayed for the operator. Moreover, when the display unit 40 is configured as, for example, a display mounted on a device other than the hydraulic excavator 1 such as a centralized operation device for remotely operating a plurality of the hydraulic excavators 1, the excavated material volume estimation result can be displayed for the operator who performs a remote operation. In addition, the excavated material volume estimation result estimated by the volume estimation unit 330 may not be displayed on the display unit 40.

The parallax data obtained from the image photographed by the stereo camera device 210 is input to the bucket region setting unit 3100 and the bucket region is set on the basis of the parallax data. Then, the parallax data analysis unit 3110 divides the bucket region into meshes and obtains the mesh parallax data which is a representative value of the parallax data of each mesh on the basis of the parallax data included in each mesh.

The container determination unit 410 determines whether the inner bottom of the bucket 15 is within the photographing range of the stereo camera device 210 during the work of the hydraulic excavator 1 by using the bucket angle obtained by the angle measurement unit 320. The container determination unit 410 preliminarily has a predetermined angle range at the time in which the inner bottom of the bucket 15 falls within the photographing range of the stereo camera device 210. Then, the container determination unit 410 determines that the inner bottom is within the photographing range when the bucket angle is included in a predetermined angle range on the basis of the bucket angle and the predetermined angle range at the time in which the inner bottom of the bucket 15 falls within the photographing range of the stereo camera device 210. In addition, the angle measurement unit 320 of this embodiment obtains the bucket angle on the basis of the rotation angle measured by the angle sensor 30 provided in the hydraulic excavator 1.

The image selection unit 610 selects the photographed image used for estimating the volume of the excavated material on the basis of the existence or the size of the dead angle region. For example, when the dead angle region exists in a certain photographed image, the stereo camera device 210 photographs an image until the photographed image without the dead angle region is obtained and selects the photographed image without the dead angle region. Alternatively, for example, a method can be considered in which the photographed image with the dead angle region among the images photographed when the bucket angle is within the predetermined angle range is stored in the image selection unit 610 and the photographed image having a small dead angle region among the stored photographed images is selected when the photographed image without the dead angle region cannot be photographed. The storage location of the photographed image at this time is set as the image selection unit 610 in this embodiment. Here, the storage location is not limited to the image selection unit 610. In addition, the image selection unit 610 has been described such that the photographed image used to estimate the volume of the excavated material is selected and stored. However, the image which is selected and stored by the image selection unit 610 is not limited to the photographed image. For example, the image may be a parallax image which will be described later and is obtained on the basis of the photographed image.

The volume estimation unit 330 estimates the volume of the excavated material by using the mesh parallax data obtained by using the photographed image selected by the image selection unit 610. That is, the volume estimation unit 330 estimates the volume of the excavated material inside the bucket 15 when the inner bottom of the bucket 15 is within the photographing range of the stereo camera device 210.

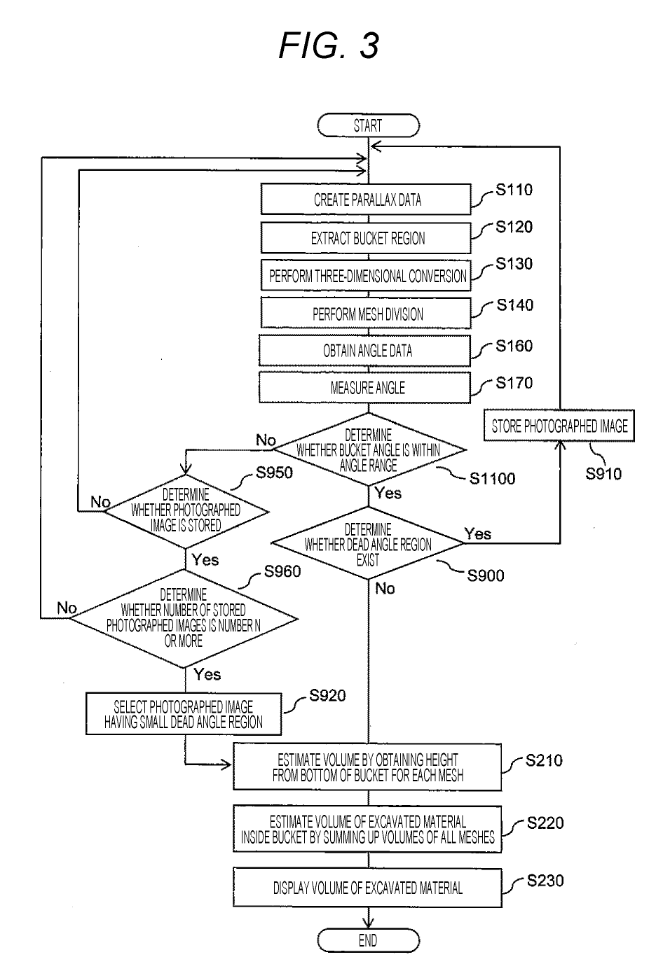

FIG. 3 illustrates a flowchart of estimating the volume of the excavated material by determining whether the inner bottom of the bucket 15 is within the photographing range of the stereo camera device 210.

<S110>

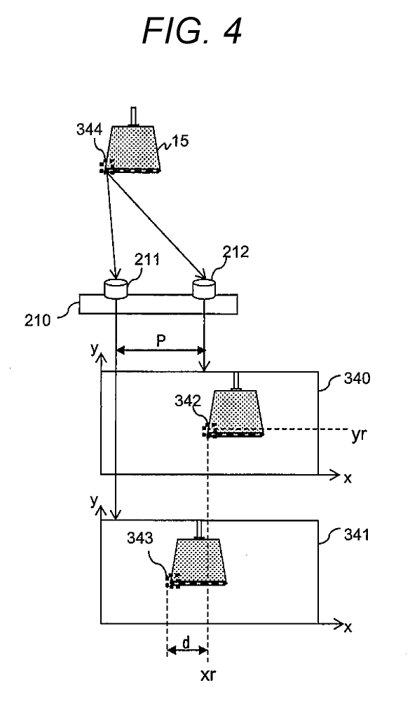

First, the bucket 15 is photographed by the stereo camera device 210 and the parallax data is created by using the photographed image. As will be described later in FIG. 4, a method of creating the parallax data is to obtain a coordinate difference for a subject between a left image 341 and a right image 340. When the coordinate difference is obtained for the entire photographed image, the parallax image which is the parallax data of the image photographed by the stereo camera device 210 is obtained.

<S120>

Next, the bucket region is set by the bucket region setting unit 3100. The bucket 15, the ground, or the earth and sand may be photographed by the stereo camera device 210 during the excavation. As a method of setting the bucket region among these subjects, the bucket region which is closer to the stereo camera device 210 rather than the ground or the earth and sand is used. That is, since the parallax data of the bucket region extremely increases compared to the region of the ground or the earth and sand in the periphery thereof, the bucket region can be set by using the parallax data.

<S130>

Next, the parallax data of the set bucket region is three-dimensionally converted to match the real size by the parallax data analysis unit 3110.

<S140>

Next, the three-dimensionally converted bucket region is divided into a two-dimensional mesh by the parallax data analysis unit 3110. As the mesh size becomes smaller, the accuracy of the excavated material volume estimation becomes better.

<S160>

Next, the rotation angle of each of the boom 13, the arm 14, and the bucket 15 is obtained by using the angle sensor 30 of the angle measurement unit 320.

<S170>

Next, the bucket angle is measured by the angle measurement unit 320 on the basis of the rotation angle.

<S1100>

Next, it is determined whether the bucket angle is within a predetermined angle range during the work by the container determination unit 410. When the bucket angle is within the predetermined angle range, the routine proceeds to S900. When the bucket angle is not within the predetermined angle range, the routine proceeds to S950.

<S900>

When it is determined that the bucket angle is within the

predetermined angle range in S1100, it is determined whether the dead angle region exists in the bucket region by the dead angle determination unit 510. When the dead angle region exists in the bucket region, the routine proceeds to S910. When the dead angle region does not exist in the bucket region, the routine proceeds to S210.

<S910>

When it is determined that the dead angle region exists in the bucket region in S900, the photographed image is stored in the image selection unit 610. That is, the photographed image is stored in the image selection unit 610 until it is determined that the dead angle region does not exist in the bucket region. In this embodiment, a case in which a plurality of photographed images are stored instead of overwriting is exemplified.

<S950>

When it is determined that the bucket angle is not within the predetermined angle range in S1100, it is determined whether the photographed image is stored in the image selection unit 610. When the photographed image is stored in the image selection unit 610, the routine proceeds to S960. When the photographed image is not stored in the image selection unit 610, the routine returns to S110.

<S960>

When it is determined that the photographed image is stored in S950, it is determined whether the number of the photographed images stored in the image selection unit 610 is a predetermined number N or more. When the number of the photographed images stored in the image selection unit 610 is the predetermined number N or more, the routine proceeds to S920. When the number of the photographed images stored in the image selection unit 610 is smaller than the predetermined number N, the routine returns to S110.

<S920>

When it is determined that the number of the photographed images stored in the image selection unit 610 is the predetermined number N or more in S960, for example, the photographed image having a small dead angle region is selected from the stored photographed images by the image selection unit 610. The size of the dead angle region can be determined by, for example, the size of the mesh parallax data.

<S210>

When it is determined that the dead angle region does not exist in the bucket region in S900, the volume estimation unit 330 estimates the volume of the excavated material for each mesh by obtaining a length from the bottom of the bucket 15 to the surface of the excavated material for each of the two-dimensional meshes using the photographed image without the dead angle region. As the next step of S920, the volume estimation unit 330 estimates the volume of the excavated material for each mesh by using the photographed image selected in S920.

<S220>Next, the volume estimation unit 330 estimates the volume of the excavated material inside the bucket 15 by summing up the volumes of the excavated materials of all meshes.

<S230>

Next, the estimated volume of the excavated material is displayed on the display unit 40.

In the steps of FIG. 3, a process is performed using the photographed image, for example, by storing the photographed image in the image selection unit 610 in S910 or determining whether the number of the photographed images stored in the image selection unit 610 is the predetermined number N or more in S960. However, the image used in the steps of FIG. 3 is not limited to the photographed image, and the steps of FIG. 3 may be performed by using, for example, the parallax image which will be described later, obtained on the basis of the photographed image.

In FIG. 4, an outline of an operation of creating the parallax data by the stereo camera device 210 will be described. When the right image 340 obtained by photographing the bucket 15 using the right camera 212 and the left image 341 obtained by photographing the bucket 15 using the left camera 211 exist, a part 344 of the bucket 15 is photographed at the position of a point 342 in the right image 340 and is photographed at the position of a point 343 in the left image 341. As a result, a parallax d is generated at the point 342 and the point 343. The parallax d becomes a large value when the excavated material inside the bucket 15 is close to the stereo camera device 210 and becomes a small value when the excavated material is far from the stereo camera device 210. The parallax d obtained in this way is obtained for the entire photographed image. The parallax data can be obtained on the basis of the parallax d. The parallax data obtained for the entire photographed image is set as the parallax image. A distance from the excavated material inside the bucket 15 to the stereo camera device 210 can be measured by the principle of triangulation using the parallax d. When the parallax d is used, a distance Q₁ is obtained by the following equation.

Q₁=(f×P)/d

Here, f indicates a focal distance of each of the right and left cameras and P indicates a distance between the right camera 212 and the left camera 211. Further, in order to three-dimensionally convert the parallax data, the positions X₁ and Y₁ in the three-dimension at the point obtaining Q₁ described above are expressed by the following equation.

X₁=(Q₁×xᵣ)/f

Y₁=(Q₁×yᵣ)/f

Here, xr indicates the x coordinate on the right image 340 and yr indicates the y coordinate on the right image 340. As described above, the position (X₁, Y₁, Q₁) of the subject in the three-dimensional space can be obtained by the distance from the stereo camera device 210 on the basis of the image photographed by the stereo camera device 210.

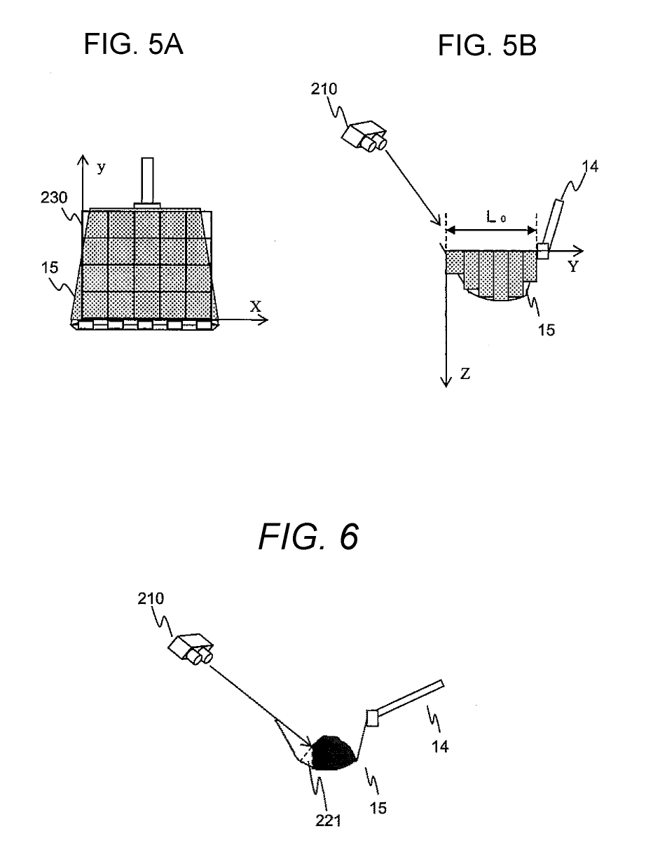

FIG. 5 illustrates an outline of a method of estimating the volume of the excavated material and a description will be made on the assumption that the opening surface of the bucket 15 faces above. FIG. 5(a) is an image in which the bucket 15 is viewed from the front side of the stereo camera device 210 and the bucket 15 is photographed by the stereo camera device 210 from the oblique upside of the bucket 15. FIG. 5(b) is a cross-sectional view of the bucket 15 which is parallel to the side surface of the arm 14. The right direction of FIG. 5(a) is set as the +X-axis direction and the up direction is set as the +Y-axis direction. Then, the right direction of FIG. 5(b) is set as the +Y-axis direction and the down direction is set as the +Z-axis direction. Then, the length of the bucket 15 in the Y-axis direction is set as L₀.

The mesh parallax data of each mesh of a mesh group 230 is obtained by using the parallax data included in each mesh. A method of obtaining the mesh parallax data is not limited to one method and, for example, a method of obtaining mesh parallax data on the basis of a center value or an average value of a plurality of parallax data items inside the mesh or a method of obtaining mesh parallax data on the basis of a center value or an average value after reducing the number of the parallax data items may be considered. Further, when the mesh is set densely, the mesh in which one parallax data is included in the mesh is generated. In this case, the mesh parallax data and the parallax data have the same value.

Since the bottom of the bucket 15 cannot be photographed while the excavated material exists in the bucket 15, it is desirable to learn the shape of the bucket 15 in advance. As a method of learning the shape of the bucket 15, a method is considered in which the empty bucket 15 is photographed by the stereo camera device 210, the photographed image is divided by the mesh, and a distance from the bottom of the bucket 15 to the bucket opening surface for each mesh is calculated. Alternatively, the shape of the bucket may be learned from. CAD data.

When a length from the bucket opening surface of the bucket 15 to the surface of the excavated material in each mesh while the excavated material is included therein is obtained, a length from the bottom of the bucket 15 to the bucket opening surface when the bucket 15 is empty is obtained, and the two lengths are added for each mesh, it is possible to obtain a length from the bottom of the bucket 15 to the surface of the excavated material for each mesh. Then, it is possible to estimate the volume of the excavated material inside the bucket 15 by calculating the volume of the excavated material for each mesh using a height from the bottom of the bucket 15 to the surface of the excavated material for each mesh and summing up the volumes of the excavated materials in all meshes.

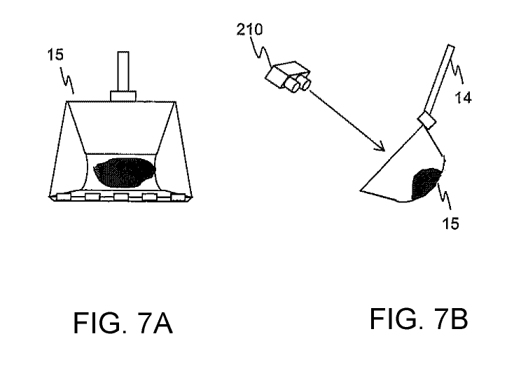

FIG. 6 illustrates an example when a dead angle region 221 is generated inside the bucket region by the side surface of the bucket 15. When the bucket angle is out of a predetermined angle range, there is a case in which the dead angle region 221 is generated inside the bucket region by the side surface of the bucket 15. Then, as illustrated in FIG. 6, there is concern that the excavated material maybe included in the dead angle region 221 generated by the side surface of the bucket 15.

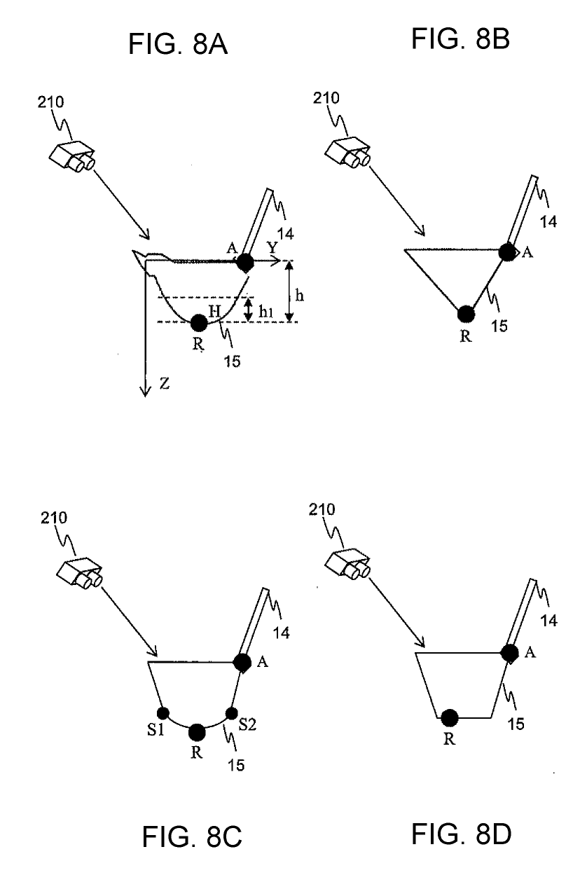

FIG. 7 illustrates the photographed image of the stereo camera device 210 when the inner bottom of the bucket 15 is within the photographing range of the stereo camera device 210. FIG. 7(a) is a diagram illustrating the bucket 15 viewed from the front side of the stereo camera device 210 and FIG. 7(b) is a cross-sectional view of the bucket 15, which is parallel to the side surface of the arm 14. Since the stereo camera device 210 is provided inside the cab 22, the bucket 15 is photographed from the oblique upside. From FIG. 7, when the inner bottom of the bucket 15 is within the photographing range of the stereo camera device 210, it is possible to prevent the dead angle region 221 from being generated by the side surface of the bucket 15 described in FIG. 6. Accordingly, it is possible to highly accurately estimate the volume of the excavated material.

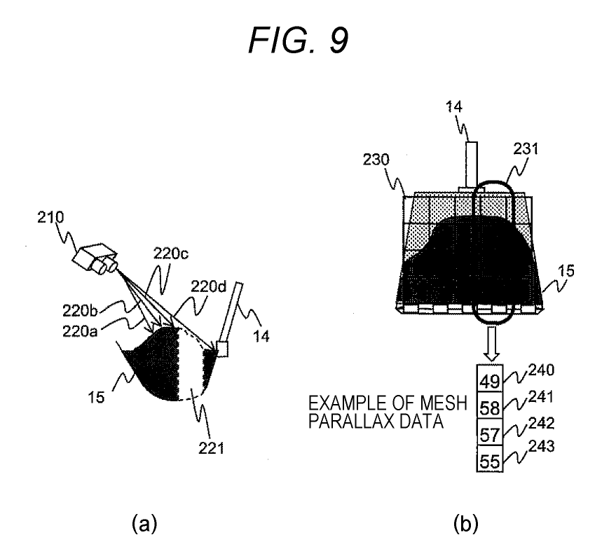

FIG. 8 is a diagram illustrating the buckets 15 having four different shapes. Hereinafter, the inner bottom of the bucket 15 will be defined by using the buckets 15 having four different shapes while the opening surfaces of the buckets 15 face above in FIG. 8.

FIG. 8(a) is a cross-sectional view of the bucket 15 in which the inner shape of the bucket is formed in a curved shape and which is parallel to the side surface of the arm 14. FIG. 8(b) is a cross-sectional view of the bucket 15 in which the inner shape of the bucket is formed in a linear shape and which is parallel to the side surface of the arm 14. FIG. 8(c) is a cross-sectional view of the bucket 15 in which the inner shape of the bucket is formed in a curved shape and a linear shape and which is parallel to the side surface of the arm 14, where a point S1 and a point S2 indicate joints of curved and linear parts. FIG. 8(d) is a cross-sectional view of the bucket 15 in which the shape of the inner bottom of the bucket is flat and which is parallel to the side surface of the arm 14. In FIG. 8, a connection point between the bucket 15 and the arm 14 is set as a point A. In the cross-sectional view of the bucket 15 which is parallel to the side surface of the arm 14, the lowest point in the +Z-axis direction is set as a point R. In the case of FIG. 8(d), there are many lowest points in the +Z-axis direction. Thus, an arbitrary point of the lowest part in the +Z-axis direction is set as the point R.

First, an example of the inner bottom of the bucket 15 is illustrated by FIG. 8(a). When the length from the point R to the opening surface is indicated by h, a length h₁ is set to 10% or less of h. In that case, the inner surface portion of the bucket 15 inside a region H formed by the inner surface of the bucket 15 and the line separated from the point R by h₁ in parallel to the opening surface of the bucket 15 is set as the inner bottom of the bucket 15. This method can be also applied to FIGS. 8(b), 8(c), and 8(d). For example, when a length of 10% of h is set as h₁ in the case where the bucket has a substantially semi-circular cross-section, the cross-sectional area of the inner bottom of the bucket 15 becomes about 4% of the entire cross-sectional area of the bucket 15.

In addition, a method of setting a line forming the point R as the inner bottom of the bucket 15 may be considered. For example, since the line forming the point R is a curve in FIG. 8(c), the curved part between the point S1 and the point S2 is set as the inner bottom of the bucket 15. This method can be applied to FIG. 8(d).

In addition, a method of defining the point R as the inner bottom of the bucket 15 may be considered. This method can be applied to FIGS. 8(a), 8(b), 8(c), and 8(d).

Further, as illustrated in FIG. 6, when there is a need to prevent the excavated material from being included in the dead angle region 221 generated by the side surface of the bucket 15, the entire inside of the bucket 15 does not need to be essentially included in the photographing range of the stereo camera device 210. That is, it is desirable that the inner surface of the bucket 15 close to the stereo camera device 210 in the inner surface of the bucket 15 be included in the photographing range. Thus, for example, in the case of FIG. 8(c), the region of the inner bottom of the bucket 15 may be set as the periphery of the point Si except for the periphery of the point S2.

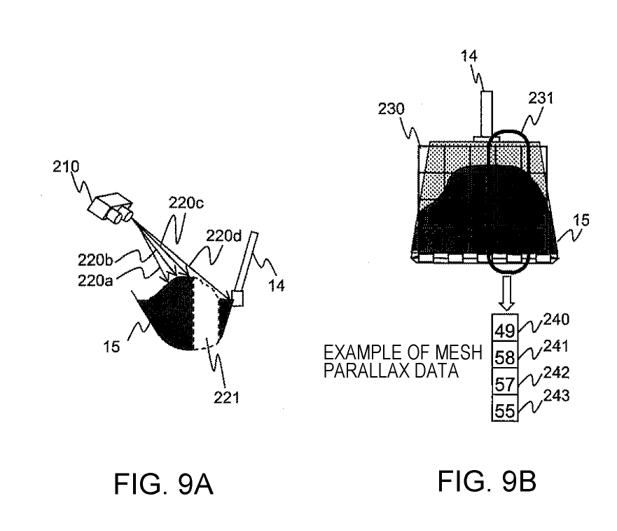

FIG. 9 illustrates an example of the mesh parallax data when the dead angle region 221 is generated inside the bucket region. FIG. 9(a) is a cross-sectional view of the bucket 15 which is parallel to the side surface of the arm 14. When the excavated material is in a mountainous state, the back side of the mountain as viewed from the stereo camera device 210 becomes the dead angle region 221. FIG. 9(b) is a diagram in which the bucket 15 obtained from the photographed image is divided into the two-dimensional mesh group 230. The mesh corresponding to a distance 220a from the stereo camera device 210 to the excavated material is set as a mesh 243, the mesh corresponding to a distance 220b from the stereo camera device 210 to the excavated material is set as a mesh 242, the mesh corresponding to a distance 220c from the stereo camera device 210 to the excavated material is set as a mesh 241, and the mesh corresponding to a distance 220d from the stereo camera device 210 to the excavated material is set as a mesh 240.

When focusing on one row 231 of the mesh group 230, the mesh parallax data changes with a difference of about 1 or 2 from the mesh 243 to the mesh 241. However, the mesh parallax data from the mesh 241 to the mesh 240 decreases by 9. This is because the distance 220d from the stereo camera device 210 to the excavated material becomes larger than the distance 220c. In this way, the dead angle determination unit 510 determines that the dead angle region 221 exists between the meshes in which the mesh parallax data suddenly decreases.

Since it is determined whether the dead angle region 221 exists in the bucket region, the photographed image without the dead angle region 221 in the bucket region can be used to estimate the volume of the excavated material. Accordingly, it is possible to more accurately estimate the volume of the excavated material.

According to the above-described method, when the inner bottom of the bucket 15 is within the photographing range of the stereo camera device 210, that is, the bucket angle is within a predetermined angle range, it is possible to decrease the dead angle region in the bucket region generated by the side surface of the bucket 15 on the photographed image. Thus, it is possible to highly accurately estimate the volume of the excavated material inside the bucket 15. Then, since a predetermined angle range is used to determine whether the bucket 15 is in the photographing range, it is possible to estimate the volume of the excavated material without moving the bucket 15 to a specific position for the photographing.

Further, since it is determined whether the bucket 15 is within the photographing range during the work, it is possible to estimate the volume of the excavated material without stopping the operation of the bucket 15. That is, since there is no need to perform a specific operation for estimating the volume of the excavated material, it is possible to estimate the volume of the excavated material during the normal work. Accordingly, it is possible to highly efficiently estimate the volume of the excavated material.

In addition, a timing for estimating or displaying the volume of the excavated material may not be immediately after the determination that no dead angle region is found in S900 of FIG. 3 or S920 of FIG. 3. For example, the timing may be the time while the hydraulic excavator 1 turns or the time before the hydraulic excavator 1 performs the soil discharge operation. In this way, the timing may be before each operation during the work or the time between the operations. In addition, for example, a routine maybe exited from the loop of the flowchart of FIG. 3 at the switching timing from the excavating operation to the turning operation and proceeds to S210 of FIG. 3 to estimate or display the volume of the excavated material.

Further, when the photographed image or parallax image having the smallest dead angle region in S920 of FIG. 3 is selected even when the dead angle region exists in all photographed images or parallax images, it is possible to highly accurately estimate the volume of the excavated material.

Further, the volume of the excavated material may be estimated many times by proceeding to S110 of FIG. 3 instead of S230 of FIG. 3 after estimating the volume of the excavated material in S220 of FIG. 3. Accordingly, it is possible to display the volume of the excavated material by obtaining an average value or a center value of the value of the estimated volume of the excavated material, for example, on the basis of the plurality of excavated material volume estimation results. Accordingly, it is possible to more accurately estimate the volume of the excavated material.

Further, when the hydraulic excavator 1 performs, for example, an operation in which the bucket angle θ falls into and out of a predetermined angle range according to the determination of 5960 in FIG. 3, it is possible to suppress a problem in which the photographed image used for estimating the volume of the excavated material is selected from a small number of the photographed images. That is, it is possible to estimate the volume of the excavated material when a certain number of the photographed images are stored. Accordingly, it is possible to select the photographed image capable of estimating the more accurate volume of the excavated material.

### Second Embodiment

As a second embodiment, an example of obtaining the bucket angle on the basis of the parallax data obtained from the stereo camera device 210 instead of the rotation angle obtained from the angle sensor 30 is illustrated.

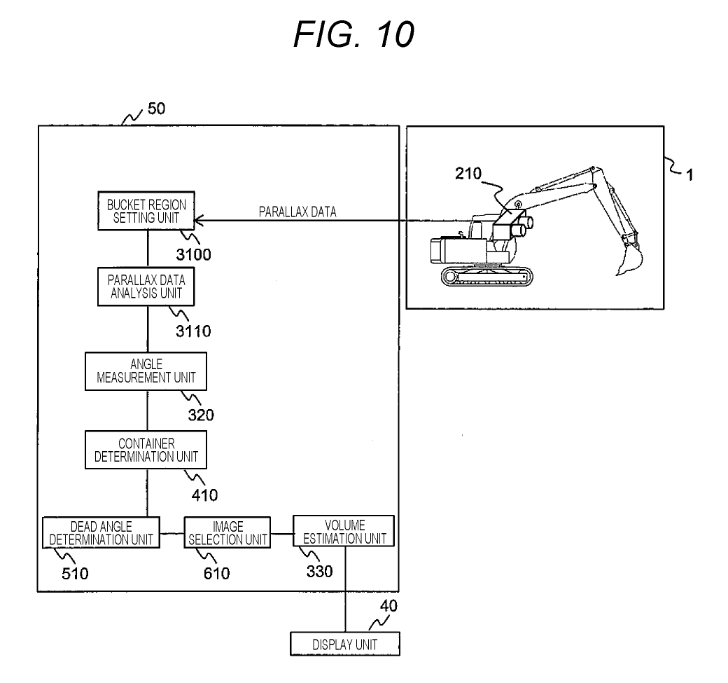

FIG. 10 illustrates a configuration diagram of the volume estimation apparatus 50 mounted on the hydraulic excavator 1 of the second embodiment. Compared to FIG. 2 which is a configuration diagram of the first embodiment, the angle measurement unit 320 obtains the bucket angle on the basis of the image photographed by the stereo camera device 210 instead of obtaining the bucket angle on the basis of the rotation angle measured by the angle sensor 30.

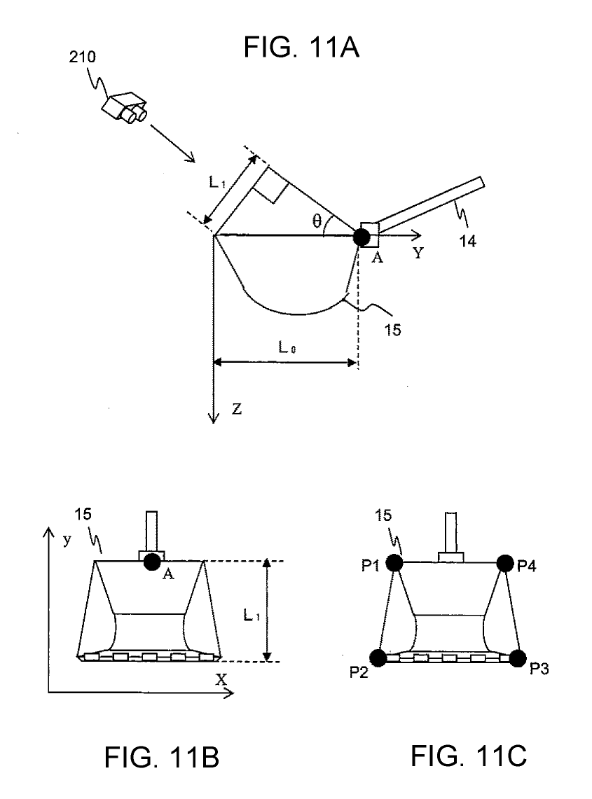

FIG. 11 illustrates an example of obtaining the bucket angle θ from the parallax data in the second embodiment. FIG. 11(a) is a cross-sectional view of the bucket 15 which is parallel to the side surface of the arm 14. FIG. 11(b) is a diagram illustrating the bucket 15 viewed from the front side of the stereo camera device 210. This drawing is an image obtained by photographing the bucket 15 using the stereo camera device 210 from the oblique upside of the bucket 15.

In FIG. 11(b), a length of the bucket 15 in the y-axis direction as viewed from the front side of the stereo camera device 210 is set as L₁. The bucket angle θ is obtained by θ=sin⁻¹ (L₁/L₀). As described above, it is possible to obtain the bucket angle on the basis of the photographed image of the stereo camera device 210.

FIG. 11(c) is a diagram obtained by assigning the numbers P1 to P4 to four corner points of FIG. 11(b). The length L₁ is not limited to the length which is parallel to the y axis and a length, for example, from P1 to P2 may be set to L₁. In addition, a length from P3 to P4 may be set to L₁ and L₁ may be obtained by using an average value of the length from P1 to P2 and the length from P3 to P4. In addition, for example, when P1 to P4 are included in the dead angle region generated by the excavated material inside the bucket 15, a point other than four corner points of the bucket 15 may be used as a point obtaining L₁.

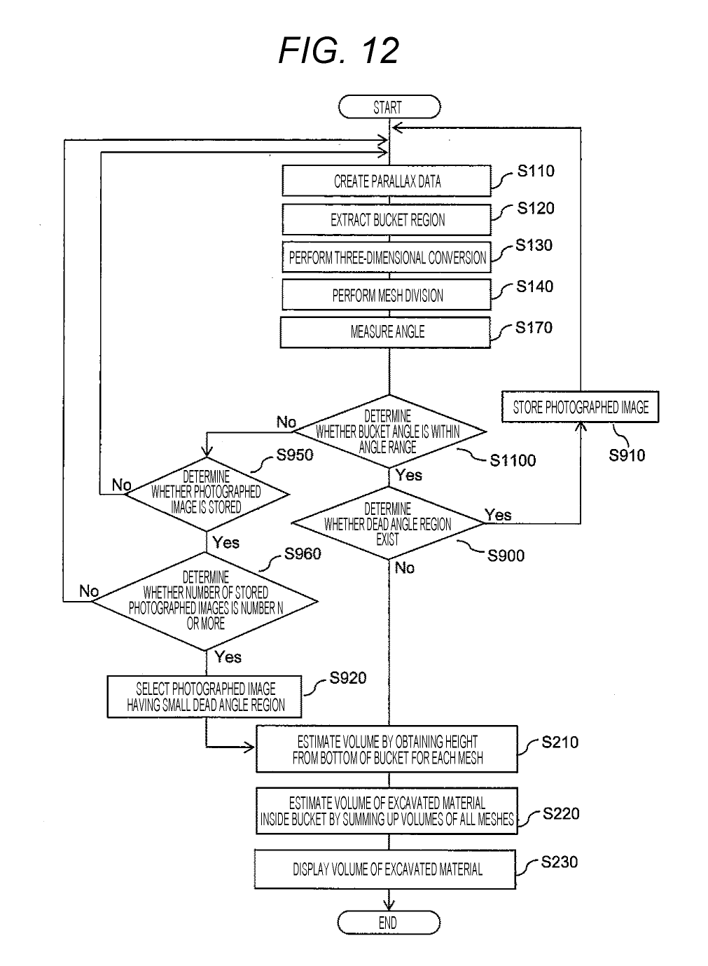

FIG. 12 illustrates a flowchart for determining whether the inner bottom of the bucket 15 is within the photographing range of the stereo camera device 210 in the second embodiment. In the first embodiment, the bucket angle is measured by using the rotation angle. The second embodiment is different from FIG. 3 in that S160 does not exist since the bucket angle is measured by using the photographed image or the parallax data. Then, this embodiment is also different from. FIG. 3 in that the angle measurement unit 320 obtains the bucket angle on the basis of the image photographed by the stereo camera device 210 in S170.

According to the above-described method, it is possible to estimate the bucket angle by using the photographed image obtained from the stereo camera device 210. In this method, a time delay hardly occurs, for example, when a process of correlating the photographed image of the stereo camera device 210 with the angle measured by the angle sensor 30 is performed compared to the case of estimating the bucket angle using the angle sensor 30.

Further, in the second embodiment, the bucket angle is obtained on the basis of the parallax data obtained from the stereo camera device 210. However, it may be determined whether the inner bottom of the bucket 15 is within the photographing range of the stereo camera device 210 on the basis of a value other than the bucket angle. For example, it maybe determined whether the inner bottom of the bucket 15 is within the photographing range of the stereo camera device 210 on the basis of the length L₁ of the bucket 15 in the y-axis direction viewed from the front side of the stereo camera device 210 and obtained from the parallax data.

### Third Embodiment

As a third embodiment, an example of determining whether the inner bottom of the bucket 15 is within the photographing range of the stereo camera device 210 in consideration of the position range of the bucket 15 along with the angle range is illustrated.

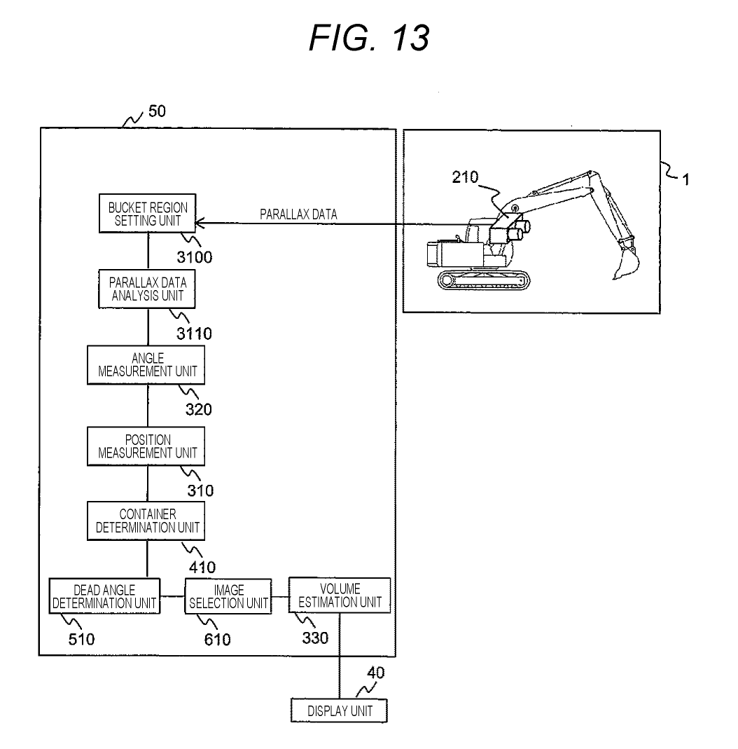

FIG. 13 is a configuration diagram of the volume estimation apparatus 50 mounted on the hydraulic excavator 1 of the third embodiment. FIG. 13 is different from FIG. 10 which is a configuration diagram of the second embodiment in that a position measurement unit 310 measuring the current position of the bucket 15 with respect to the stereo camera device 210 is provided. The position measurement unit 310 measures the current position of the bucket 15 with respect to the stereo camera device 210 by using the parallax data of the bucket region obtained from the stereo camera device 210. Then, the container determination unit 410 preliminarily has a predetermined angle range and a predetermined position range which can be highly accurately photographed by the stereo camera device 210.

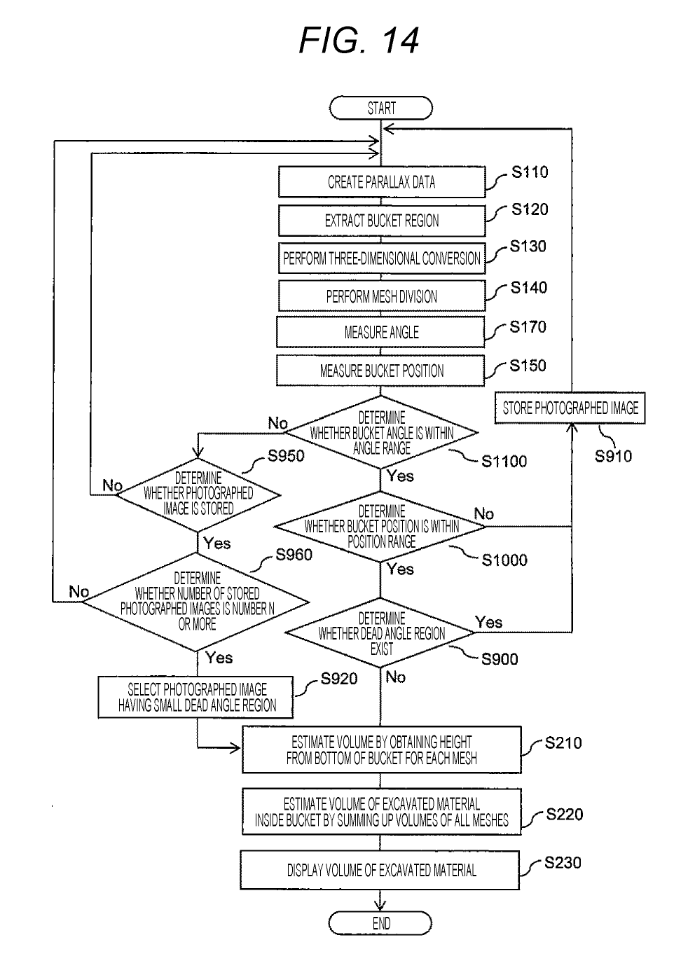

FIG. 14 illustrates a flowchart for determining whether the inner bottom of the bucket 15 is within the photographing range of the stereo camera device 210 of the third embodiment. The third embodiment is different from FIG. 12 in that S150 for obtaining the current position of the bucket 15 and S1000 for determining whether the bucket position is within a predetermined position range are provided since the current position of the bucket 15 is obtained and a determination on whether the position is within the predetermined position range is made.

For example, as described in FIG. 11, the position of point A of the bucket 15 in a three-dimensional coordinate system is set as a point A (X1, Y1, Q₂). Q2 indicates a distance from the stereo camera device 210 to the point A. By the following equation illustrated in FIG. 4, it is understood that the parallax d and the distance Q₂ have an inverse proportional relationship. That is, it is understood that the photographing accuracy of the stereo camera device 210 is deteriorated as the distance from the stereo camera device 210 to the measurement object becomes longer.

Q₂=(f×P)/d

Here, the container determination unit 410 determines whether the bucket angle is within a predetermined angle range on the basis of a predetermined angle range and a predetermined position range of the bucket 15 with respect to the stereo camera device 210 and determines whether the current position of the bucket 15 with respect to the stereo camera device 210 obtained by the position measurement unit 310 is within the predetermined position range.

For example, when the predetermined position range which can be highly accurately photographed by the stereo camera device 210 is indicated by S, it is possible to obtain the photographed image in which the photographing accuracy of the stereo camera device 210 is not deteriorated by determining a case in which the position of the point A is included in the predetermined position range S as a case where the position is within the photographing range. Accordingly, it is possible to highly accurately obtain the parallax data. Further, it is possible to highly accurately estimate the volume of the excavated material.

Further, a method of determining whether the inner bottom of the bucket 15 is within the photographing range of the stereo camera device 210 by first using the predetermined angle range rather than the predetermined position range can be also considered.

When the bucket angle is within the predetermined angle range, the inner bottom of the bucket 15 is also within the photographing range regardless of whether the current position of the bucket 15 is within the predetermined position range. However, when the current position of the bucket 15 is within the predetermined position range, the inner bottom of the bucket 15 does not enter the photographing range in accordance with the bucket angle. Thus, since the angle range is more important than the position range in order to allow the bucket position within the photographing range, it is possible to reduce the calculation amount for estimating the volume of the excavated material by determining whether the bucket position is within the photographing range first using the angle range rather than the position range.

In addition, the working machine provided with the bucket and represented as the hydraulic excavator generally performs an excavating operation of excavating earth and sand, a turning operation of turning the bucket to discharge an excavated material into a transporting machine, a loading operation of discharging earth and sand to the transporting machine, a turning operation of turning the bucket to an excavating position, and an excavating/loading operation of alternately repeating these operations to fill the transporting machine with earth and sand. At this time, it is considered that the excavated material inside the bucket substantially does not exist until the excavating operation starts from the loading operation. Thus, it is desirable not to estimate the volume of the excavated material until the excavating operation starts from the loading operation at the time of estimating the volume for the purpose of estimating the volume of the excavated material. Meanwhile, the volume of the excavated material is estimated until the excavating operation starts from the loading operation at the time of estimating the volume for the purpose of estimating the volume of the excavated material remaining in the bucket after the loading operation. Thus, an operation of not estimating the volume of the excavated material may be set in accordance with the purpose or the volume of the excavated material may be estimated regardless of whether the excavated material exists inside the bucket and the volume estimation result may be stored in, for example, a ROM to obtain the volume of the excavated material discharged to the transporting machine.

In the first to third embodiments, it has been described that the volume estimation apparatus 50 is provided in the hydraulic excavator 1. However, the volume estimation apparatus may be provided in, for example, a device other than the hydraulic excavator 1 such as a centralized operation device for remotely controlling the plurality of hydraulic excavators 1. In addition, a part of the volume measurement apparatus 50 may be provided in a device other than the hydraulic excavator 1.

In the first to third embodiments, it has been described that the volume estimation apparatus 50 includes the CPU, the RAM, the ROM, and other peripheral circuits. However, for example, the volume estimation apparatus 50 may not include the CPU, the RAM, the ROM, and other peripheral circuits. In this case, when the processes of the components of the volume estimation apparatus 50 are stored in an external memory or the like, the volume estimation apparatus 50 can be handled as the volume estimation system. Then, the processes of the components of the volume estimation system may be performed by using the CPUs, the RAMS, the ROMs, and other peripheral circuits provided in devices other than the volume estimation system.

Further, the volume estimation target is not limited to the excavated material in the bucket. Other than the excavated material in the bucket, the volume of an object inside any container may be estimated.

In addition, in this embodiment, the excavated material inside the bucket of the hydraulic excavator is set as the volume estimation target, but the volume of a load of a dump or the like may be targeted.

### REFERENCE SIGNS LIST

1 hydraulic excavator
10 lower traveling body
11 upper turning body
13 boom
14 arm
15 bucket
22 cab
30b to 30d angle sensor
40 display unit
50 volume estimation apparatus
210 stereo camera device
221 dead angle region
230 mesh group
310 position estimation unit
320 angle measurement unit
330 volume estimation unit
410 container determination unit
3100 bucket region setting unit
3110 parallax data analysis unit
510 dead angle determination unit
610 image selection unit

1. A volume estimation apparatus comprising:
a container determination unit which determines whether an inner bottom of a container is within a photographing range of a plurality of cameras during a work of a moving body including the container and the plurality of cameras; and
a volume estimation unit which estimates a volume of an object inside the container when the inner bottom of the container is within the photographing range of the plurality of cameras.

2. The volume estimation apparatus according to claim 1, comprising:
an angle measurement unit which obtains an angle formed between an opening surface of the container and the plurality of cameras,
wherein the container determination unit determines whether the inner bottom of the container is within the photographing range of the plurality of cameras on the basis of the angle formed by the opening surface of the container and the plurality of cameras and a predetermined angle range at the time in which the inner bottom of the container is within the photographing range of the plurality of cameras.

3. The volume estimation apparatus according to claim 1,
wherein the angle measurement unit obtains the angle formed by the opening surface of the container and the plurality of cameras on the basis of an image photographed by the plurality of cameras.

4. The volume estimation apparatus according to claim 1, comprising:
a dead angle determination unit which determines whether a dead angle region exists in the object inside the container.

5. The volume estimation apparatus according to claim 2, comprising:
a position measurement unit which obtains a position of the container with respect to the plurality of camera,
wherein the container determination unit determines whether a position of the container with respect to the plurality of cameras is within a predetermined position range on the basis of the position of the container with respect to the plurality of cameras and the predetermined position range of the container with respect to the plurality of cameras.

6. The volume estimation apparatus according to claim 5,
wherein the container determination unit determines whether the inner bottom of the container is within the photographing range of the plurality of cameras by first using the predetermined angle range rather than the predetermined position range.

7. A working machine comprising:
the volume estimation apparatus according to claim 1.

8. A volume estimation system comprising:
a container determination unit which determines whether an inner bottom of a container is within a photographing range of a plurality of cameras during a work of a moving body including the container and the plurality of cameras; and
a volume estimation unit which estimates a volume of an object inside the container when the inner bottom of the container is within the photographing range of the plurality of cameras.
